(19) United States
(12) Patent Application Publication
(10) Pub. No.: US 2006/0005413 A1
(43) Pub. Date: Jan. 12, 2006

(54) Work piece positioning apparatus

(76) Inventors: Jaydeep K. Sinha, E Norwood, MA (US); John F. Valley, Tucson, AZ (US); Ethan W. Clark, Brookline, MA (US)

Correspondence Address: LaValle D. Ptak, Ste. B, 28435 N. 42nd St., Cave Creek, AZ, 85331, US

(21) Appl. No.: 10/888,697

(22) Filed: Jul. 9, 2004

(51) Int. Cl. B23Q 16/00

(52) U.S. Cl. 33/568

(57) ABSTRACT

An apparatus for positioning a work piece along a Z-axis includes a base having a depression with an open top in it forming a chamber. A cover member has a rigid central portion and a rigid outer portion coupled with the central portion by an intermediate flexure. The cover member overlies and is secured to the base member at the outer portion of the cover member to close the chamber. Fluid under pressure applied to the chamber is used to move the central portion of the cover member along the Z-axis proportionally to the pressure of fluid applied to the chamber by flexing of the flexure.

### BACKGROUND

This invention is in the field of apparatus for positioning an item, such as a semiconductor wafer, vertically or along a Z-axis for processing, examination or evaluation.

### BRIEF DESCRIPTION OF THE DRAWINGS

FIG. 1 is a partially cut-away top perspective view of an embodiment of the invention;

FIG. 2 is a top perspective cut-away of a portion of the embodiment shown in FIG. 1;

FIG. 3 is a cross-sectional view of the embodiment shown in FIG. 1;

FIG. 4 is an exploded view of the embodiment shown in FIGS. 1,2 and 3;

FIG. 5 is a side view illustrating operation of the embodiment shown in FIGS. 1 through 4; and

FIGS. 6,7,8,9 and 10 are graphs illustrating different operating characteristics of the embodiment of the invention shown in FIGS. 1 through 5.

### DETAILED DESCRIPTION

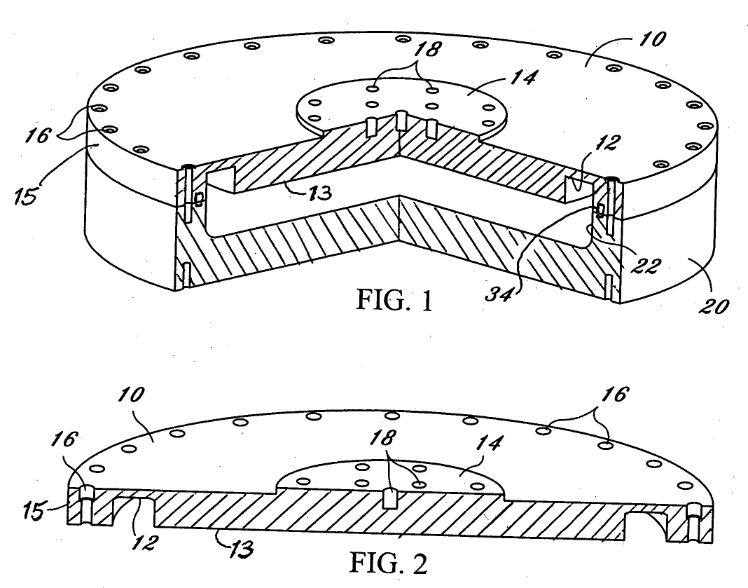

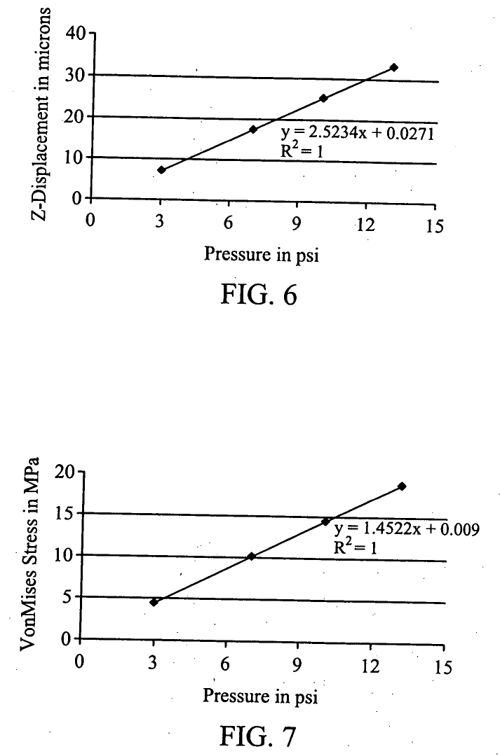

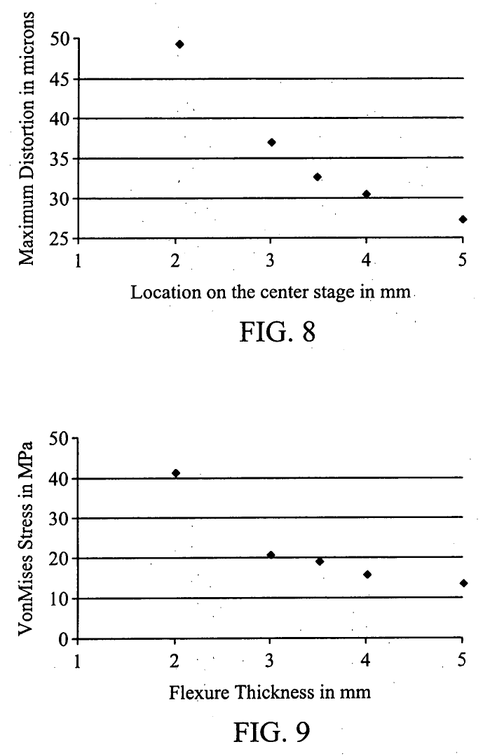

Reference now should be made to the drawings, in which the same reference numbers are used throughout the different figures to designate the same or similar components. FIGS. 1 through 4 show an embodiment of an invention useful as a vertical or Z-axis positioning device for precisely locating a platform beneath microscopes or other equipment, such as phase shift interferometers, for evaluation of thin films or wafers placed on the platform. Typically, the platform is used in conjunction with the production and inspection of semiconductor wafers of relatively large diameters (200 mm or greater), with the wafer being placed on top of a chuck 40 (FIGS. 4 and 5), which is raised and lowered along the Z-axis by the apparatus shown in FIGS. 1 through 5.

The device shown in FIGS. 1 through 5 is the operating portion of an overall platform which is useful in evaluating semiconductor wafers or other devices located in an x-y or horizontal plane. In such devices, and in other systems used in the semiconductor processing industry, it is desirable to provide positioning of a wafer relative to other equipment (not shown) over a relatively wide range, for example, from 2 microns to 400 microns, with a position control accuracy within a few nanometers, typically within five nanometers.

In the device which is illustrated in FIGS. 1 through 5 of the drawings, the platform adjustment for moving a platform chuck 40 in a vertical or Z-axis direction is illustrated. The chuck 40 may be heavy, for example, on the order of 15 to 20 pounds, in part to assist in the dampening of vibrations. A semiconductor wafer or other device which is to be evaluated, tested or in part fabricated in systems using the tool shown in FIGS. 1 through 5 is placed on the top of the chuck 40.

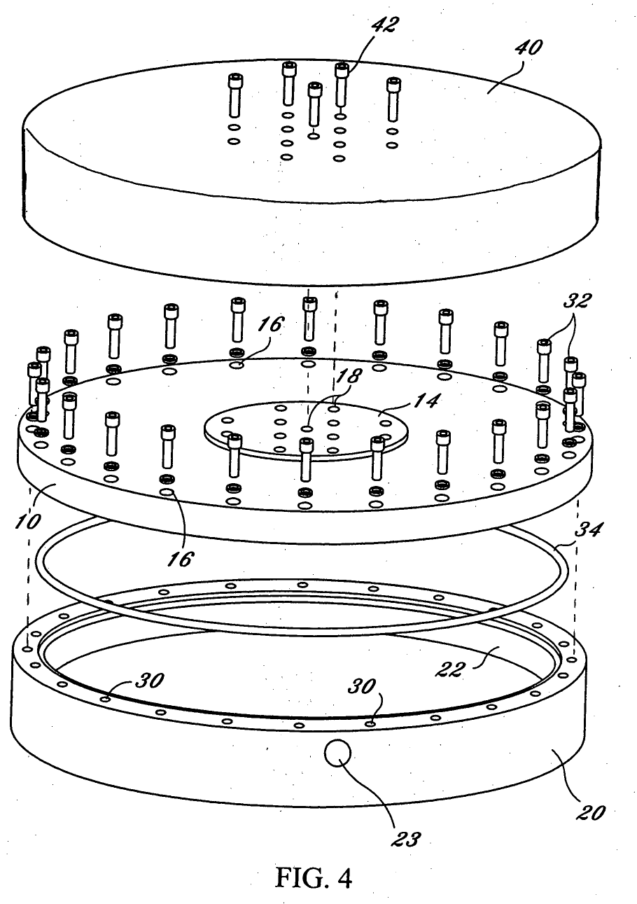

The platform lifting or elevating apparatus which is illustrated consists of a base member 20 in the form of a circular or cylindrical mass having a hollowed out circular depression 22 extending downwardly from its top surface approximately one-half of the distance into the thickness of the base 20. This depression substantially forms a rigid closed cavity when a cylindrical or circular top cover member 10 is secured about its outer periphery to the top of the base member 20, around the outer periphery of the member 20, to make an enclosed cavity, as illustrated most clearly in FIGS. 1 and 3.

The base member 20 and cover member 10 may be fabricated from any suitable material having the desired mechanical and thermal properties. The mechanical properties include the ability to machine the material for the cover 10 and the base 20, and particularly the cover 10. In addition, the accuracy of the positioning performed by the apparatus requires that the material out of which the parts 10 and 20 are made has relatively high thermal diffusivity, defined as characterization of how fast heat travels through the material, and how much heat the material retains which has as variables thermal conductivity and specific heat.

Materials which have a high diffusivity are desirable, since the symmetry of the cover components help reduce errors induced by changes in temperature if the entire part has uniform temperature changes. If heat builds up on one side of the cover 10, non-linear positional errors would result. Materials but of which the cover 10, and to a lesser extent the base 20, may be fabricated include aluminum, stainless steel, titanium, beryllium-copper and invar. All of these materials exhibit desirable properties for the apparatus which is shown in the embodiment of FIGS. 1 through 5. Aluminum and stainless steel are common, and therefore are relatively inexpensive, with reasonable machinability. Titanium and beryllium-copper are not as common; although these materials are still widely used. Titanium and beryllium-copper have good machinability, but are more expensive than aluminum and stainless steel. Invar has excellent thermal properties and will expand and contract the least when subjected to thermal changes. This material, however, is the most expensive of the five materials, and also is the most difficult to machine, especially for relatively large work pieces. The diameter of the base 20 and cover 10 is on the order of 10″ to 12″, which makes invar a fairly expensive choice.

It has been found that an aluminum alloy, known as aluminum 7075-T6 is very effective for the operating environment and the physical characteristics required. Aluminum also has a significant advantage inasmuch as it is readily available and relatively inexpensive, as well as being relatively easy to machine. Aluminum also has a high fatigue cycle.

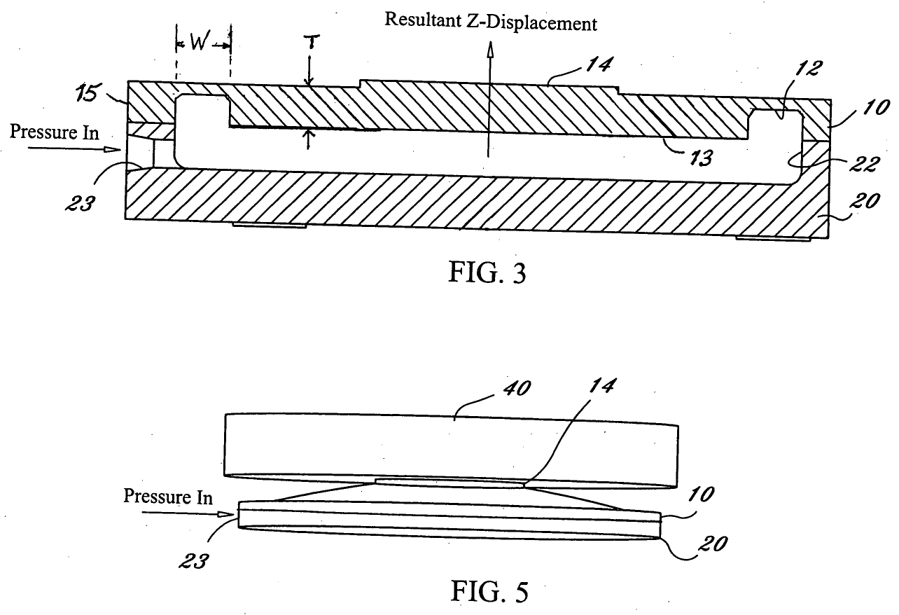

In the device illustrated in FIGS. 1 through 5, the primary thickness of the cover 10, with the exception of a circular flexural area 12, is approximately ¾″ thick. On at least the central part of the center portion, a slightly raised platform 14 extends, as seen most clearly in FIGS. 1 and 3. The flexural area 12 is machined to leave a thickness of approximately 2 mm to 4 mm forming a movable hinge between the center portion carrying the platform 14 and the outer edge of the cover 10. This relief 12 is machined so that the edges where the vertical removal of material meets the horizontal top (as viewed in FIGS. 2 and 3) are beveled at an angle (approximately 25°) to relieve stress concentrations which otherwise would be inducted by a right angle meeting of the vertical and horizontal surfaces. This slight beveling is shown most clearly in FIG. 3.

To attach the cover 10 to the base 20, a plurality of holes 16 are provided in the cover to mate with a corresponding plurality of tapped holes 30 in the base 20. A rubber O ring 34 or other suitable sealing gasket is provided, as shown most clearly in FIGS. 1 and 4, to seal the cover 10 to the base 20 when suitable threaded fasteners 32 are inserted through the holes 16 to seat in the corresponding tapped holes 30 in the base 20. This causes a sandwich construction of the type shown most clearly in FIGS. 1 and 3 to exist. As a consequence, a sealed chamber is produced between the cover 10 and the depression in the base 20; and this chamber is designed to be fluid-tight.

An opening 23 is provided in the base 20 extending into the chamber, as shown most clearly in FIGS. 3 and 4, to allow the introduction of air by hydraulic fluid under pressure to be applied to the chamber 22. As the pressure is increased, a Z-axis upward displacement pressure is formed against the underside of the cover 10. The cover 10 flexes at the flexure 12 to move the center portion 15 with the platform 14 upwardly with increased pressure, and to drop the center portion downwardly as the pressure is reduced. Apparatus for supplying fluid pressure to the chamber 22 may be any suitable precision controlled apparatus for measuring the amount of fluid pressure and the rate of change of that pressure in order to achieve the desired Z-axis displacement translation quickly, accurately and effectively. It should be noted that movement of the platform 14 along the Z-axis is uniform without tilting. By way of example, a 0.01 PSI pressure change is reflected into a change of 0.1 microns in Z-axis displacement of the raised center 14 of the cover member 10, with a device having the overall dimensions outlined above.

It should be noted that the width W of the reduced thickness channel, which provides the intermediate flexure between the outer periphery of the cover 10 and the central portion having the platform 14 on it, can be varied, as well as varying the thickness T of the cover 10 in the region of the channel 12. These changes will modify the amount of flex provided for any given unit of pressure change; and these dimensions may be varied to fit the particular operating conditions of any specific application to be made of the platform positioning device which is illustrated.

As shown in FIGS. 4 and 5, the platform positioning device may be used to lift a table or chuck 40 on which the part to be fabricated or evaluated is to be placed. FIG. 4 shows the manner in which this chuck 40 is attached to the raised central area 14 by means of threaded fasteners 42, which pass through holes in the chuck 40 to be seated in tapped holes 18 formed on the platform 14. Any suitable technique for securing the chuck 40 to the top of the platform 14 may be utilized, however.

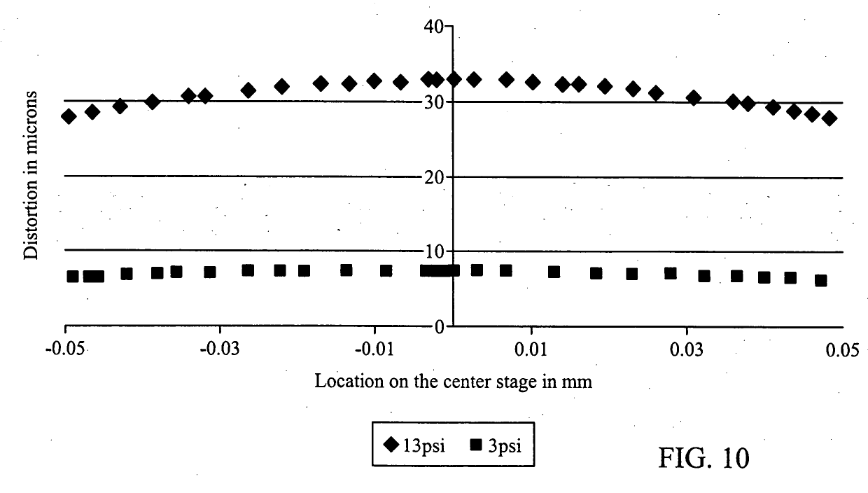

It should be noted that the device which has been described above and which is shown in FIGS. 1 through 5 produces a near linear Z-axis displacement (along the central axis of the parts 10 and 20) in microns, as pressure changes of the air applied to the opening 23 to the chamber 22 are effected. The change in displacement versus pressure in PSI is shown in FIG. 6. Similarly, the VonMises stress with respect to pressure and PSI also is linear, as shown in FIG. 7.

FIG. 8 plots the location of the center platform or stage 14 in millimeters versus the maximum distortion in microns; and FIG. 9 plots the flexure thickness in millimeters, with VonMises stress. It can be seen that nearly linear plots are made in both of these measurements.

Finally, FIG. 10 is a plot of the location on the center stage (platform 14) in millimeters versus the distortion in microns, as fluid pressure varies from 3 PSI to 13 PSI for a specific implementation of a device having the overall dimensions mentioned previously. By changing the width or thickness of the flexure 12 and by modifying the thickness of the cover 10, different Z-axis movement in response to applied pressure also will be obtained; but the linearity which is depicted in FIGS. 6 through 10 still is maintained. Very accurate position control in response to precisely measured changes in air pressure may be effected (including negative pressure which would result in a downward movement of the platform 14 from the position shown in FIG. 3); so that precision positioning of materials placed on the chuck 40 is provided by the disclosed apparatus.

The foregoing description of an embodiment of the invention is to be considered illustrative and not as limiting. Various changes and modifications will occur to those skilled in the art for performing substantially the same function, in substantially the same way, to achieve substantially the same result without departing from the true scope of the invention as defined in the appended claims.

What is claimed is:

1. Apparatus for positioning a work piece along a Z-axis including in combination: a base member having a depression therein open at the top forming a chamber; a cover member having a rigid central portion and a rigid outer portion coupled with the center portion by an intermediate flexure, the cover member overlying and secured to the base member at the outer portion of the cover member to close the chamber depression; and means for applying fluid under pressure to the chamber to flex the flexure and move the central portion of the cover member along the Z-axis proportionally to the pressure of fluid applied to the chamber.

2. Apparatus according to claim 1 wherein the flexure has a circular configuration.

3. Apparatus according to claim 1 wherein the cover member including the central portion, intermediate portion, and outer portion, is made of a single unitary piece.

4. Apparatus according to claim 3 wherein the cover member is made of metal.

5. Apparatus according to claim 4 wherein the metal is aluminum.

6. Apparatus according to claim 5 wherein the cover member and the base member have a circular configuration and are coaxial with one another, and wherein the Z-axis is the central axis of the cover member and base member.

7. Apparatus according to claim 1 wherein the cover member and the base member have a circular configuration and are coaxial with one another, and wherein the Z-axis is the central axis of the cover member and base member.

8. Apparatus according to claim 2 wherein the cover member including the central portion, intermediate portion, and outer portion, is made of a single unitary piece.

9. Apparatus according to claim 1 wherein the flexure is made of metal.

10. Apparatus according to claim 9 wherein the metal is selected from the group consisting of aluminum, stainless steel, titanium, beryllium-copper, and invar.

11. Apparatus according to claim 9 wherein the metal is aluminum.

12. Apparatus for positioning a work piece in the form of thin flat wafers by moving the work piece along a Z-axis, the apparatus including in combination: a base member having a depression therein and open on the top; a circular cover member having a central axis, the cover member having a circular rigid central portion and a circular rigid outer portion interconnected with the central portion by an intermediate flexure, the cover member overlying and secured to the base member at the outer portion thereof to close the depression in the base member, forming an airtight chamber; and means for applying fluid pressure to the chamber to displace the central portion of the cover member along the Z-axis proportionally to the pressure of fluid applied to the chamber.

13. Apparatus according to claim 12 wherein the flexure portion is provided by a region of reduced thickness relative to the thicknesses of the central portion and of the outer portion of the cover member.

14. Apparatus according to claim 12 wherein the cover member is made of metal.

15. Apparatus according to claim 14 wherein the intermediate flexure has a thickness which is substantially less than the thickness of the central portion of the cover member.

16. Apparatus according to claim 15 wherein the means for applying fluid under pressure is provided by an aperture in the base member communicating with the depression therein.

17. Apparatus according to claim 16 further including means for supporting a work piece to the central portion of the cover member.

18. Apparatus according to claim 14 wherein the cover member is made of metal selected from the group consisting of aluminum, stainless steel, titanium, beryllium-copper and invar.

19. Apparatus according to claim 12 wherein the means for applying fluid under pressure is provided by an aperture in the base member communicating with the depression therein.

20. Apparatus according to claim 12 wherein the intermediate flexible portion of the cover member has a thickness which is substantially less than the thickness of the central portion of the cover member.

21. Apparatus according to claim 12 wherein the physical structure of the flexure causes displacement of the central member along the Z-axis to be uniform without tilt as fluid pressure is applied to the chamber.
